(19) United States
(12) Patent Application Publication
(10) Pub. No.: US 2025/0016494 A1
(43) Pub. Date: Jan. 9, 2025

(54) HEADSET EARPHONE FOR REDUCING NOISE AND WITH COAXIAL PLANAR SPEAKER

(71) Applicant: Dongguan Roker Electronics Co., Limited, Dongguan (CN)

(72) Inventors: KEQIANG LI, Dongguan (CN); YONGXIANG ZOU, Dongguan (CN)

(21) Appl. No.: 18/231,613

(22) Filed: Aug. 8, 2023

(30) Foreign Application Priority Data
Jul. 4, 2023 (CN) 202321735417.3

(51) Int. Cl. H04R 1/24; H04R 1/10; H04R 7/06; H04R 9/06

(52) U.S. Cl. CPC H04R 1/24; H04R 1/1008; H04R 7/06; H04R 9/063; H04R 1/1075

(57) ABSTRACT

The present disclosure provides a headset earphone for reducing noise including an earphone body, where an interior of the earphone body is provided with a first moving-coil speaker responsible for an intermediate frequency sound and a low frequency sound, and a planar speaker or a second moving-coil speaker responsible for the intermediate frequency sound and a high frequency sound; a center of the first moving-coil speaker and a center of the planar speaker or the second moving-coil speaker are on the same central axis; the headset earphone of the present disclosure is arranged in a coaxial manner. Thus, the sound performance has a stronger integrity, it can better reflect the depth of the sound and generally improve a full audio performance of the earphone, and thereby meeting the Sony high-definition audio Hires standard.

### CROSS-REFERENCE TO RELATED APPLICATIONS

This is a U.S. patent application which claims the priority and benefit of Chinese Patent Application Number 202321735417.3, filed on Jul. 4, 2023, the disclosure of which is incorporated herein by reference in its entirety.

### TECHNICAL FIELD

The present disclosure relates to the field of earphone technologies, and in particular, to a headset earphone for reducing noise and with a coaxial planar speaker.

### BACKGROUND

Most existing headset earphones use a moving-coil speaker, and some earphones use a single moving-coil speaker and a high frequency moving-coil speaker. A large moving-coil speaker has a good performance in an intermediate frequency sound and a low frequency sound and a bad performance in a high frequency sound. Using the high-frequency moving-coil speaker to compensate for the high frequency sound, a range of the sound that can be reached is limited and cannot meet the Sony high-definition audio Hires standard.

Regarding this, a headset earphone for reducing noise and with a coaxial planar speaker is proposed.

### SUMMARY

In view of this, an embodiment of the present disclosure aims to provide a headset earphone for reducing noise and with a coaxial planar speaker to solve or alleviate a technical problem existing in the prior art, and at least provide a beneficial choice.

The technical solution of the embodiment of the present disclosure is implemented as follows: a headset earphone for reducing noise and with a coaxial planar speaker including an earphone body, where an interior of the earphone body is provided with a first moving-coil speaker responsible for an intermediate frequency sound and a low frequency sound, and a planar speaker or a second moving-coil speaker responsible for the intermediate frequency sound and a high frequency sound:
a center of the first moving-coil speaker and a center of the planar speaker or the second moving-coil speaker are on the same central axis.

In an embodiment, a filter mesh is provided between the first moving-coil speaker and the planar speaker or the second moving-coil speaker.

In an embodiment, the earphone body is provided with a buffer pad.

In an embodiment, one side of the earphone body is fixedly connected to a connection base.

In an embodiment, an interior of the earphone body that is located at one side of the planar speaker or the second moving-coil speaker is provided with a microphone.

Due to the above technical solutions are used in the embodiment of the present disclosure, and the present disclosure has the following advantages:
the headset earphone (reducing noise) of the present disclosure is arranged in a coaxial manner, the first moving-coil speaker responsible for the intermediate frequency sound and the low frequency sound and the planar speaker or the second moving-coil speaker responsible for the intermediate frequency sound and the high frequency sound are superimposed on the same axis, thus, the sound performance has a stronger integrity, it can better reflect the depth of the sound and generally improve a full audio frequency performance of the earphone, and thereby meeting the Sony high-definition audio Hires standard.

The above description is only for a purpose of explaining the present disclosure and is not intended to be limited in any way. In addition to an exemplary aspect, implementation mode, and feature described above, further aspects, implementation modes, and features of the present disclosure will be easily understood by referring to the drawings and the following detailed description.

### BRIEF DESCRIPTION OF DRAWINGS

In order to provide a clearer explanation of the technical solution of the embodiment of the present disclosure or technical solution in the prior art, a brief introduction will be given to the drawing required in the description of the embodiment or the description of the prior art. It is obvious that the drawings in the following description are only some drawings of the present disclosure. For ordinary technical personnel in the art, other drawings can be obtained based on these drawings without any creative work.

FIG. 1 is a structural diagram of a headset earphone of an embodiment of the present disclosure.

FIG. 2 is a structural diagram of the headset earphone without a buffer pad of an embodiment of the present disclosure.

FIG. 3 is a structural diagram of the headset earphone without a filter mesh of an embodiment of the present disclosure.

FIG. 4 is a section structure diagram of the headset earphone of an embodiment of the present disclosure.

Number reference: 1. Earphone body; 11. Connection base; 2. Buffer pad; 3. Second moving-coil speaker; 4. Microphone; 5. First moving-coil speaker; 6. Filter mesh.

### DETAILED DESCRIPTION

In the following description, only some exemplary embodiments have been briefly described. As those skilled in the art may recognize, the described embodiments can be modified in various ways without departing from the spirit or scope of the present disclosure. Therefore, the drawings and descriptions are considered essentially exemplary rather than limitation.

It should be noted that terms “first”, “second”, “symmetrical”, “array”, etc. are only used for a purpose of distinguishing description or a positional description, and cannot be understood as indicating or implying a relative importance or implying the quantity of technical feature indicated. Therefore, those features defined as “first” and “symmetrical” can explicitly or implicitly include one or more features; similarly, when there is no quantitative restriction on a certain feature in a form of wording such as “two” or “three”, it should be noted that the feature also explicitly or implicitly includes one or more features.

In the present disclosure, unless otherwise specified and limited, terms “installation”, “connection”, “fixation”, etc. should be understood broadly; for example, it can be a fixed connection, a detachable connection, or an integrated molding; it can be a mechanical connection, a direct connection, a welding connection, or an indirect connection through an intermediate medium; it can be an internal connection between two components or an interaction relationship between two components. For ordinary technical personnel in the art, a specific meaning of the above term in the present disclosure can be understood based on the drawing of the present disclosure and a specific circumstance.

The following is a detailed explanation of the embodiments of the present disclosure in combination with the drawings.

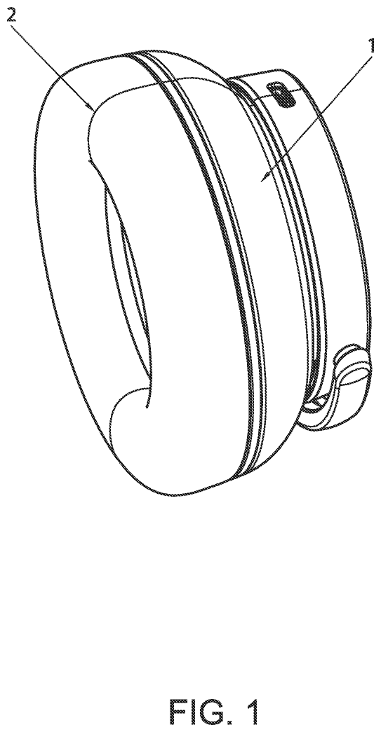

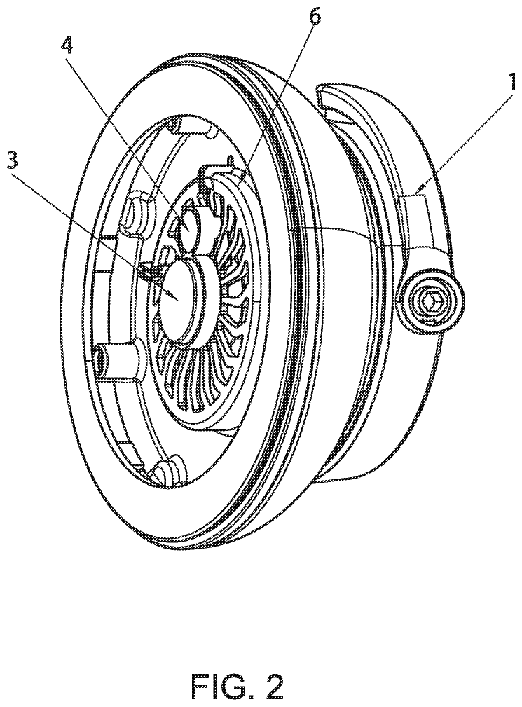

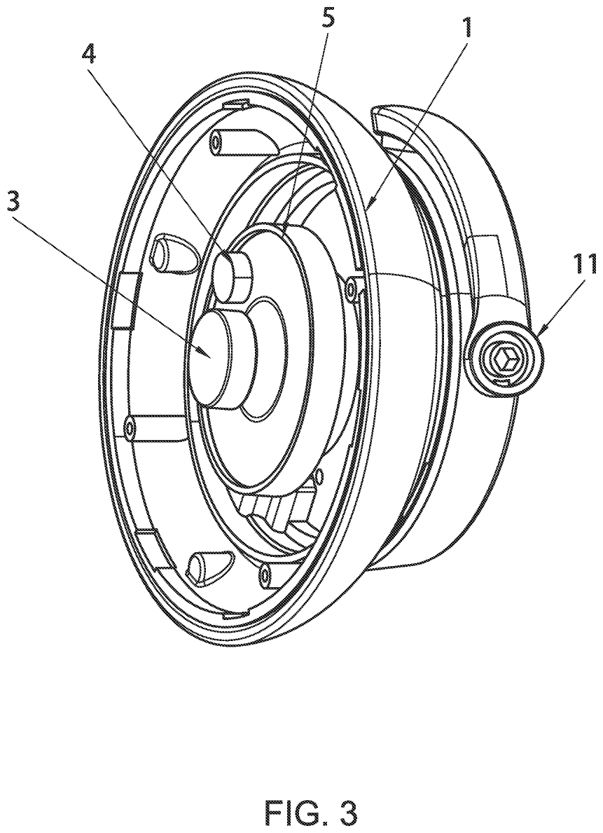

As shown in FIGS. 1-4, an embodiment of the present disclosure provides a headset earphone for reducing noise and with a coaxial planar speaker, which includes an earphone body 1, where an interior of the earphone body 1 is provided with a first moving-coil speaker 5 responsible for an intermediate frequency sound and a low frequency sound, and a planar speaker or a second moving-coil speaker 3 responsible for the intermediate frequency sound and a high frequency sound;

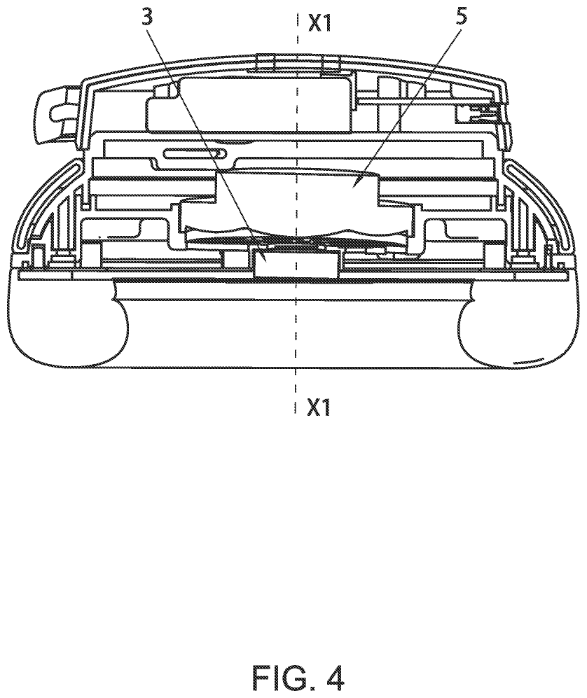

a center of the first moving-coil speaker 5 and a center of the planar speaker or the second moving-coil speaker 3 are on the same central axis. The central axis is shown in X1-X1 of FIG. 4. By arranging the headset earphone with reducing noise of the present disclosure in a coaxial manner, that is, the center of the first moving-coil speaker 5 and the center of the planar speaker or the second moving-coil speaker 3 on the same central axis. Thus, the sound performance has a stronger integrity and generally improve a full audio performance of the earphone.

In an embodiment, specifically, a filter mesh 6 is provided between the first moving-coil speaker 5 and the planar speaker or the second moving-coil speaker 3 for filtering some dust.

In an embodiment, the earphone body 1 is provided with a buffer pad 2. The buffer pad 2 is used to provide a cushioning effect and improve comfort when wearing headphone body 1 on the head.

In an embodiment, one side of the earphone body 1 is fixedly connected to a connection base 11. The connection base 11 is used to connect the earphone body with another earphone body by a headset bracket.

In an embodiment, an interior of the earphone body 1 that is located at one side of the planar speaker or the second moving-coil speaker 3 is provided with a microphone for conversation.

When the headset earphone of the present disclosure is in operation, the headset earphone (reducing noise) is arranged in a coaxial manner, the first moving-coil speaker 5 (exhibiting the intermediate frequency sound and the low frequency sound) and the planar speaker or the second moving-coil speaker 3 (planar speaker or the second moving-coil speaker 3 exhibiting the high frequency sound is better the first moving-coil speaker 5 exhibiting the high frequency sound) are superimposed on the same axis. Thus, the sound performance has a stronger integrity, it can better reflect the depth of the sound and generally improve a full audio performance of the earphone, and thereby meeting the Sony high-definition audio Hires standard.

The above description is only a specific implementation mode of the present disclosure, but the protection scope of the present disclosure is not limited to this. Any technical personnel in the art can easily think of various changes or substitutions within the technical scope disclosed by the present disclosure, which should be covered within the protection scope of the present disclosure. Therefore, the protection scope of the present disclosure should be based on the protection scope of the claims.

What is claimed is:

1. A headset earphone for reducing noise, comprising an earphone body (1), wherein, an interior of the earphone body (1) is provided with a first moving-coil speaker (5) responsible for an intermediate frequency sound and a low frequency sound, and a planar speaker or a second moving-coil speaker (3) responsible for the intermediate frequency sound and a high frequency sound;
a center of the first moving-coil speaker (5) and a center of the planar speaker or the second moving-coil speaker (3) are on the same central axis.

2. The headset earphone for reducing noise according to claim 1, wherein, a filter mesh (6) is provided between the first moving-coil speaker (5) and the planar speaker or the second moving-coil speaker (3).

3. The headset earphone for reducing noise according to claim 1, wherein the earphone body (1) is provided with a buffer pad (2).

4. The headset earphone for reducing noise according to claim 1, wherein, one side of the earphone body (1) is fixedly connected to a connection base (11).

5. The headset earphone for reducing noise according to claim 1, wherein an interior of the earphone body (1) that is located at one side of the planar speaker or the second moving-coil speaker (3) is provided with a microphone.
